(19) United States
(12) Patent Application Publication
(10) Pub. No.: US 2024/0058851 A1
(43) Pub. Date: Feb. 22, 2024

(54) Methods for Petroleum Coke Carbon Capture and Sequestration

(71) Applicant: Confair Carbon Capture Technologies, LLC, Friendswood, TX (US)

(72) Inventors: Robert Confair, Friendswood, TX (US); Michael Smith, Friendswood, TX (US)

(73) Assignee: Confair Carbon Capture Technologies, LLC, Friendswood, TX (US)

(21) Appl. No.: 18/143,760

(22) Filed: May 5, 2023

Related U.S. Application Data
(60) Provisional application No. 63/398,917, filed on Aug. 18, 2022.
(60) Provisional application No. 63/442,098, filed on Jan. 30, 2023.

(51) Int. Cl. B09B 3/70; B09B 3/35; B09B 3/40; B09B 3/45; E21B 21/06; E21B 43/20; B09B 1/00; C10B 57/00

(52) U.S. Cl. CPC B09B 3/70; B09B 3/35; B09B 3/40; B09B 3/45; E21B 21/066; E21B 43/20; B09B 1/008; C10B 57/005

(57) ABSTRACT

A petroleum coke carbon capture and sequestration method is provided which includes processing the petroleum coke into a petroleum coke particulate, preparing a slurry including the petroleum coke particulate, and injecting the slurry into an underground area. The underground area could be a live crude oil extraction well, where it could displace crude oil, an underground storage facility, a salt formation, or the like.

### RELATED APPLICATIONS

The present application claims the priority of U.S. Provisional Patent Application No. 63/398,917 filed on Aug. 18, 2022, and U.S. Provisional Patent Application No. 63/442,098 filed on Jan. 30, 2023, the entire disclosures of which are expressly incorporated herein by reference.

### TECHNICAL FIELD

The present disclosure relates to methods for petroleum coke carbon capture and sequestration, and in particular, to the production, transportation, and utilization of waste petroleum coke in the form of a petroleum coke particulate and/or coke particulate slurry.

### BACKGROUND

Carbon dioxide (CO2) is a naturally occurring chemical compound that is present in the Earth's atmosphere as a gas. Carbon dioxide is consumed by plants to produce oxygen and is the byproduct of respiration of living organisms. Carbon dioxide is also the byproduct of combustion of hydrocarbons, which can occur naturally (e.g., by way of volcanos, fires, and the like), or by artificial means (e.g., as part of various industrial processes, through the combustion of fuel sources, and the like). For example, industrial plants combust natural gas, liquefied propane gas (LPG), oil, petroleum coke, coal, waste, biofuels, and other forms of hydrocarbons as part of manufacturing and production processes. Additionally, cars, trucks, trains, planes, ships, and other means of transportation for passengers or goods combust gasoline/naphtha, kerosene/jet fuel, diesel, and bunker fuels, all of which contain hydrocarbons. A rise in the combustion of hydrocarbons over the last century, combined with a reduction of plant life (e.g., due to deforestation and the like), has led to an increase in atmospheric carbon dioxide, a greenhouse gas that is believed to trap heat in the atmosphere and cause warming of the planet. As such, increases in atmospheric carbon dioxide elevates concerns of climate change.

In an effort to reduce atmospheric carbon dioxide, carbon capture and sequestration (CCS) is now supported by several governments, including the United States. Some techniques have focused on capturing carbon dioxide from emissions produced by industrial plants and/or by converting the carbon dioxide to (e.g., solid) carbonates, so that the carbon dioxide does not enter the atmosphere. Similar CSS methods and techniques have also be applied to carbon monoxide in recent years. However, the long term economic viability and environmental impact of currently available CSS methods are still in question.

Petroleum waste is a byproduct of the petroleum refining process, which transforms crude oil into useful products, such as, for example, LPG, gasoline, kerosene, jet fuel, diesel oil, and fuel oils. Petroleum waste produced by the refining process can include, for example, petroleum coke (e.g., petcoke, green coke, sponge coke, honeycomb coke, needle coke, shot coke, raw coke, etc.), oily sludge, and the like. Petroleum coke can be burned as a low cost fuel source, however, the combustion of petroleum coke can release large amounts of carbon dioxide into the atmosphere. For example, the molecular weight of carbon is 12.0107 and the molecular weight of oxygen is 15.9994, thus carbon accounts for 27.2912% of the carbon dioxide molecule. Accordingly, every ton of carbon that is released into the atmosphere through the combustion of petroleum coke (e.g., 80-95 wt % carbon) generates roughly 3.66 tons of atmospheric carbon dioxide. Furthermore, the combustion of petroleum coke also produces emissions of sulfur and other harmful chemicals, and does not provide the energy density of more refined petroleum fuel sources (e.g., LPG, gasoline, kerosene, and jet fuel).

Accordingly, what is needed are methods for the disposition of petroleum coke, which limit the production of atmospheric carbon dioxide, provide for efficient transportation, and/or utilize the petroleum coke for other applications. Accordingly, the methods disclosed herein solve these and other needs.

### SUMMARY

The present disclosure relates to petroleum coke carbon capture and sequestration that includes processing the petroleum coke into a petroleum coke particulate, preparing a slurry including the petroleum coke particulate, and injecting the dry coke particulate or coke particulate slurry into an underground area. The underground area could be a live crude oil extraction well, where it could displace crude oil, an underground storage facility, a salt formation, or the like.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart illustrating process steps of a method for petroleum coke carbon capture and sequestration according to the present disclosure, including injecting a petroleum coke slurry into an underground area;

FIG. 2 is a flowchart illustrating process steps of another method for petroleum coke carbon capture and sequestration according to the present disclosure, including injecting a petroleum coke slurry into a crude oil extraction well;

FIG. 3 is a flowchart illustrating process steps of another method for petroleum coke carbon capture and sequestration according to the present disclosure, including producing and transporting a petroleum coke particulate and injecting a petroleum coke slurry into an underground area; and

FIG. 4 is a flowchart illustrating process steps of another method for petroleum coke carbon capture and sequestration according to the present disclosure, including producing and transporting a petroleum coke particulate and injecting a petroleum coke slurry into a crude oil extraction well.

FIG. 5 is a flow chart illustrating process steps of a method for petroleum coke carbon capture and sequestration according to the present disclosure, including injecting a petroleum coke slurry into a salt dome.

FIG. 6 is a flow chart illustrating process steps of a method for petroleum coke carbon capture and sequestration according to the present disclosure.

FIG. 7 is a schematic of a wet injection system.

FIG. 8 is a schematic showing sediments in a salt dome formation.

FIG. 9 is a schematic of a dry pneumatic transfer system.

### DETAILED DESCRIPTION

The present disclosure relates to methods for petroleum coke carbon capture and sequestration and, in particular, to the production, transportation, and utilization of waste petroleum coke by way of a petroleum coke particulate slurry. Reference is made herein to a petroleum coke particulate which includes a fine powder or even smaller particles, or larger size particles or combinations thereof.

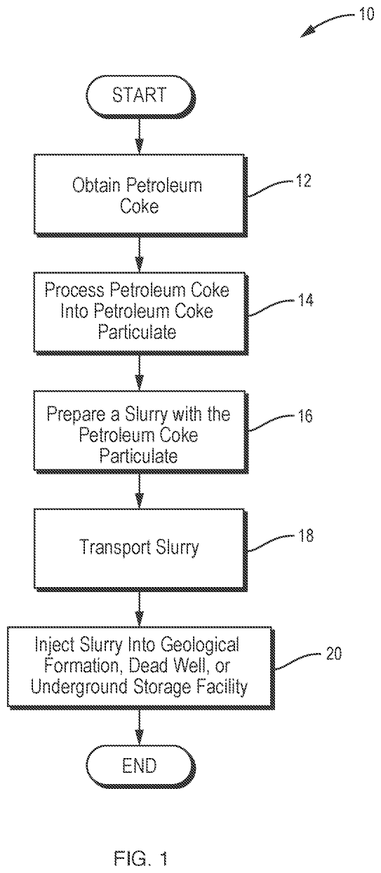

FIG. 1 is a flowchart illustrating overall process steps (hereinafter, “process 10”) for the production, transportation, and use of a petroleum coke slurry according to the present disclosure. In step 12, petroleum coke is obtained. The petroleum coke, or petcoke, can include, but is not limited to, green coke, sponge coke, honeycomb coke, needle coke, shot coke, raw coke, and the like. The petroleum coke can be generated as a byproduct of a crude oil refining process. According to one exemplary refining process, lighter fuels are removed from the crude oil via distillation (e.g., by heating the crude oil to the point of vaporization, followed by condensing the vapors back to a liquid form). The heaviest cut of the distillation, which cannot be efficiently vaporized, is called residual, or resid. The resid is fed to either a delayed or fluid “coker,” which thermally cracks the resid into smaller chain hydrocarbons (e.g., lighter fuels). The portion of the resid that does not crack or break into smaller compounds is referred to as petroleum coke, which is almost pure carbon (e.g., 80-95 wt %). It should be understood that petroleum coke is a solid and, as such, is much easier to capture, process, and handle than, for example, carbon dioxide. However, when used as a low cost fuel source, petroleum coke can release large amounts of carbon dioxide into the atmosphere. As such, processing petroleum coke without burning it can prevent the release of large amounts of carbon into the atmosphere.

In step 14, the petroleum coke is processed to produce a petroleum coke particulate. For example, the solid petroleum coke can be converted or separated into a particulate, or similar form, by way of a pneumatic cyclone, filtration or sieve, steam cutting, grinding, or other mechanical process. According to another example, the petroleum coke can be further processed into calcined coke, through a calcining process, which removes sulfur and other volatile components and converts the petroleum coke into a fine particulate. As referred to herein, petroleum coke particulate can also refer to calcined coke. It should be understood that calcined coke can provide advantages over petroleum coke when stored underground (e.g., as described in connection with process step 20, discussed hereinbelow) because the calcined coke includes fewer impurities that can pose a risk for water pollution through runoff. Additionally, the calcined coke can have a carbon content greater than 98 wt % and can be converted into graphite and anodes for the steel and aluminum industries.

It should also be understood that the petroleum coke particulate can be produced at the location where the petroleum coke is obtained, or the petroleum coke can be processed at another facility. For example, the petroleum coke can be processed into petroleum coke particulate at the facility where the petroleum coke is produced (e.g., at a crude oil refinery), or the petroleum coke can be transported to an offsite processing facility (e.g., proximate a storage facility of live crude oil extraction well) for conversion to the petroleum coke particulate. Transportation of the petroleum coke to an offsite processing facility can provide advantages, such as, but not limited to, allowing for economies of scale in the petroleum coke particulate production process and the ability to buy and sell the petroleum coke and/or petroleum coke particulate on a marketplace.

In step 16, a slurry is prepared with the petroleum coke particulate. For example, the petroleum coke particulate can be mixed with an amount of water, or other fluid, such that the slurry can flow. The ratio of petroleum coke particulate, water, or other fluid, can be selected such that the viscosity of the slurry is appropriate for a given application, such as, for example, pumping or other means of transporting the slurry.

In step 18, the slurry may be used directly or transported to an intermediate storage area, or storage facility. According to one example, the slurry can be pumped into one or more storage tanks, which can then be transported (e.g., via tanker truck, train, ship, etc.) to a storage facility, as described herein. The slurry can also be pumped directly to the storage facility, for example, by way of a pipeline running from a petroleum refining facility, or other processing facility where the petroleum coke slurry is produced, to the storage facility. It should be understood that the transportation of the petroleum coke as a slurry can provide advantages over transportation of the petroleum coke in raw form, such as a reduction in resources (e.g., vehicles and labor) required therefor. In step 20, the slurry is injected (e.g., pumped) into a geological formation, a dead crude oil extraction well, or other underground storage facility.

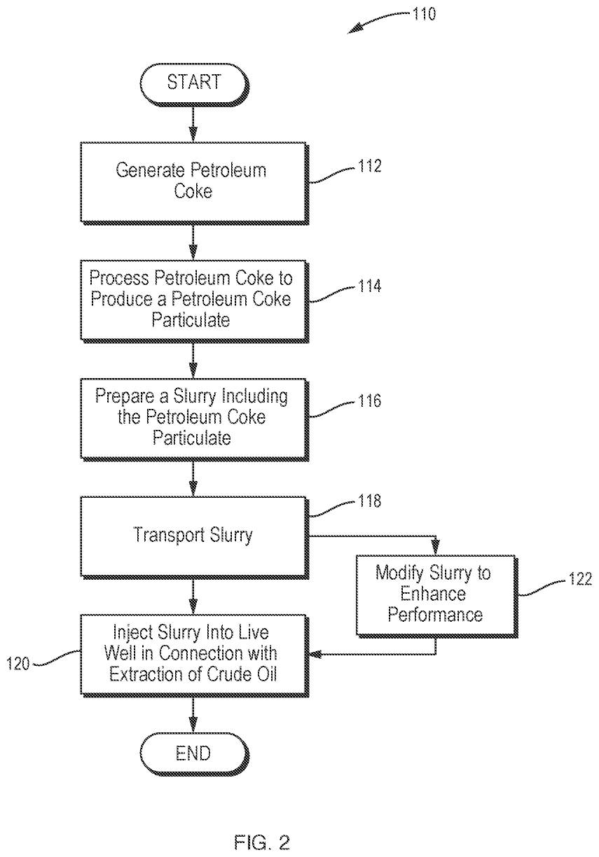

FIG. 2 is a flowchart illustrating overall process steps (hereinafter, “process 110”) for the production, transportation, and utilization of a petroleum coke slurry for crude oil extraction. In step 112, petroleum coke is generated. The petroleum coke, or petcoke, can include, but is not limited to, green coke, sponge coke, honeycomb coke, needle coke, shot coke, raw coke, and the like. The petroleum coke can be generated as a byproduct of a crude oil refining process. According to one exemplary refining process, lighter fuels are removed from the crude oil via distillation (e.g., by heating the crude oil to the point of vaporization, followed by condensing the vapors back to a liquid form). The heaviest cut of the distillation, which cannot be efficiently vaporized, is called residual, or resid. The resid is fed to either a delayed or fluid “coker,” which thermally cracks the resid into smaller chain hydrocarbons (e.g., lighter fuels). The portion of the resid that does not crack or break into smaller compounds is referred to as petroleum coke, which is almost pure carbon (e.g., 80-95 wt %). It should be understood that petroleum coke is a solid and, as such, is much easier to capture, process, and handle than, for example, carbon dioxide.

In step 114, the petroleum coke is processed to produce a petroleum coke particulate. For example, the solid petroleum coke can be converted or separated into a particulate, or similar form, by way of a pneumatic cyclone, filtration or sieve, steam cutting, grinding, or other mechanical processes. According to another example, the petroleum coke can be further processed into calcined coke, through a calcining process, which removes sulfur and other volatile components and converts the petroleum coke into a fine particulate. As referred to herein, petroleum coke particulate can also refer to calcined coke. It should be understood that calcined coke can provide advantages over petroleum coke when utilized as part of a crude oil extraction process (e.g., as described in connection with process step 120, discussed hereinbelow), because the calcined coke includes fewer impurities that can pose a risk for water pollution through runoff. Additionally, the calcined coke can have a carbon content greater than 98 wt % and can be converted into graphite and anodes for the steel and aluminum industries.

It should also be understood that the petroleum coke particulate can be produced at the location where the petroleum coke is obtained, or the petroleum coke can be processed at another facility. For example, the petroleum coke can be processed into petroleum coke particulate at the facility where the petroleum coke is produced (e.g., at a crude oil refinery), or the petroleum coke can be transported to an offsite processing facility (e.g., proximate a storage facility of live crude oil extraction well) for conversion to the petroleum coke particulate. Transportation of the petroleum coke to an offsite processing facility can provide advantages, such as, but not limited to, allowing for economies of scale in the petroleum coke particulate production process and the ability to buy and sell the petroleum coke and/or petroleum coke particulate on a marketplace.

In step 116, a slurry is prepared with the petroleum coke particulate. For example, the petroleum coke particulate can be mixed with an amount of water, or other fluid, such that the slurry can flow. The ratio of petroleum coke particulate, water, or other fluid, can be selected such that the viscosity of the slurry is appropriate for a given application, such as, for example, pumping or other means of transporting the slurry.

In step 118, the slurry is transported to an intermediate storage area, or directly to a live crude oil extraction well (e.g., as described in connection with step 120, discussed hereinbelow). According to one example, the slurry can be pumped into one or more intermediate storage tanks, for temporary storage, which can then be transported (e.g., via tanker truck, train, ship, etc.) to the live crude oil extraction well. According to another example, the slurry can also be pumped directly to the live crude oil extraction well, for example, by way of a pipeline running from a petroleum refining facility, or other facility where the petroleum coke slurry is produced, to the live crude oil extraction well. It should be understood that the transportation of the petroleum coke as a slurry can provide advantages over transportation of the petroleum coke in raw form, such as a reduction in resources (e.g., vehicles and labor) required therefor.

In step 120, the slurry is injected (e.g., pumped) into the live crude oil extraction well in order to extract crude oil therefrom. For example, the slurry can be prepared (e.g., in process step 116) and/or formulated to displace crude oil within the well. Alternatively, in optional step 122, the slurry can be further processed, or modified, at the live crude oil extraction well in order to enhance the performance of the slurry in connection with the crude oil extraction process. For example, the slurry can be prepared at the petroleum refining facility (e.g., in process step 116) with an initial composition and/or viscosity that is ideally suited for transportation of the slurry (e.g., having a low viscosity suitable for pumping through a pipeline). Thereafter, the slurry could be modified, such as, for example, by mixing the slurry with mud or other compounds, in order enhance the performance of the slurry in connection with the crude oil extraction process. According to some embodiments of the present disclosure, the slurry could be modified at a facility located at, or near, the live crude oil extraction well. After the slurry has been modified in step 122, the process advances to step 120, where the modified slurry is then injected into the live well in order to extract crude oil therefrom and then the process ends.

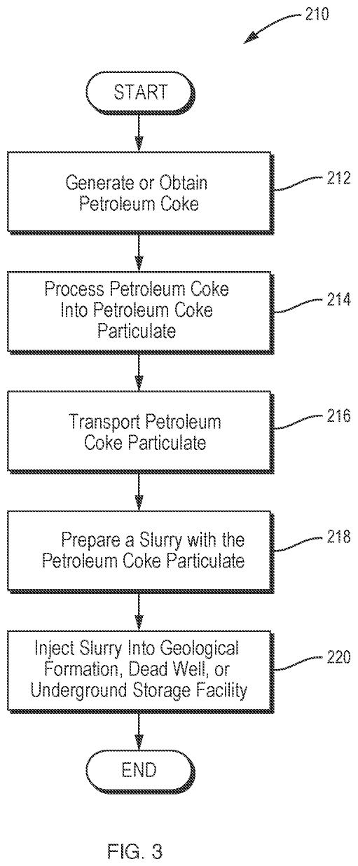

FIG. 3 is a flowchart illustrating overall process steps 210 for the production and transportation of a petroleum coke particulate, and subsequent production and use of a petroleum coke slurry according to the present disclosure. In step 212, petroleum coke is generated or obtained. For example, the petroleum coke can be generated as a byproduct of a crude oil refining process. The petroleum coke can also be obtained from another source, such as, for example, purchased by way of a marketplace. The petroleum coke, or petcoke, can include, but is not limited to, green coke, sponge coke, honeycomb coke, needle coke, shot coke, raw coke, and the like. Once the petroleum coke is generated or obtained, the process proceeds to step 214.

In step 214, the petroleum coke is processed to produce a petroleum coke particulate. For example, the solid petroleum coke can be converted or separated into a particulate, or similar form, by way of a pneumatic cyclone, filtration or sieve, steam cutting, grinding, or other mechanical process. According to another example, the petroleum coke can be further processed into calcined coke, through a calcining process, which removes sulfur and other volatile components and converts the petroleum coke into a fine particulate. As referred to herein, petroleum coke particulate can also refer to calcined coke.

It should also be understood that the petroleum coke particulate can be produced at the location where the petroleum coke is generated, or the petroleum coke can be processed at another facility. For example, the petroleum coke can be processed into petroleum coke particulate at the facility where the petroleum coke is produced (e.g., at a crude oil refinery), or the petroleum coke can be transported to an offsite processing facility (e.g., proximate a storage facility of live crude oil extraction well) for conversion to the petroleum coke particulate. Transportation of the petroleum coke to an offsite processing facility can provide advantages, such as, but not limited to, allowing for economies of scale in the petroleum coke particulate production process and the ability to buy and sell the petroleum coke and/or petroleum coke particulate on a marketplace.

In step 216, the petroleum coke particulate is transported (e.g., to a processing facility where the petroleum coke particulate is converted into a slurry, as described in connection with step 218). According to one example, the petroleum coke particulate can be transported to a processing facility that is located at, or near, an underground petroleum coke storage facility (e.g., as described in connection with step 220), where it is converted into a petroleum coke slurry. It should be understood that it can be advantageous to transport the petroleum coke as a particulate, before it is converted to a slurry for storage and/or use, where the petroleum coke is being transported by way of truck, rail, or other vessel. For example, the petroleum coke particulate in a slurry may settle and can be difficult to clear from some vessels. Furthermore, petroleum coke particulates can be boxed, bagged, toted, or transported by solid material handling trucks or rail cars, whereas the transportation of petroleum coke slurries by way of trucks or rail cars requires specially configured tanker trucks, tanker railcars, and the like.

In step 218, a slurry is prepared with the petroleum coke particulate. For example, the petroleum coke particulate can be mixed with an amount of water, or other fluid, such that the slurry can flow. The ratio of petroleum coke particulate, water, or other fluid, can be selected such that the viscosity of the slurry is appropriate for a given application, such as, for example, pumping the slurry.

In step 220, the slurry is injected (e.g., pumped) into a geological formation, a dead crude oil extraction well, or other underground storage facility. Additionally, as described above, the petroleum coke slurry can be produced at a processing facility that is located at, or near, the underground petroleum coke storage facility, which provides for streamlined storage of the slurry, as well as provides for integration or combination with other processes at or near the storage facility. For example, step 220 can include pumping the slurry from a slurry production facility/area, e.g., located proximate to an underground storage facility, and into the underground storage facility. After the slurry is injected into the underground storage facility the process ends.

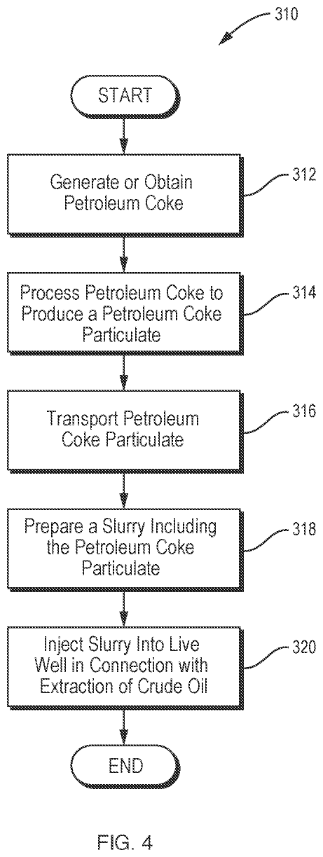

FIG. 4 is a flowchart illustrating overall process steps 310 for the production and transportation of a petroleum coke particulate, and subsequent production and use of a petroleum coke slurry according to the present disclosure. In step 312, petroleum coke is generated or obtained. For example, the petroleum coke can be generated as a byproduct of a crude oil refining process. The petroleum coke can also be obtained from another source, such as, for example, purchased by way of a marketplace. The petroleum coke, or petcoke, can include, but is not limited to, green coke, sponge coke, honeycomb coke, needle coke, shot coke, raw coke, and the like. Once the petroleum coke is generated or obtained, the process proceeds to step 314.

In step 314, the petroleum coke is processed to produce a petroleum coke particulate. For example, the solid petroleum coke can be converted or separated into a particulate, or similar form, by way of a pneumatic cyclone, filtration or sieve, steam cutting, grinding, or other mechanical processes. According to another example, the petroleum coke can be further processed into calcined coke, through a calcining process, which removes sulfur and other volatile components and converts the petroleum coke into a fine particulate. As referred to herein, petroleum coke particulate can also refer to calcined coke.

It should also be understood that the petroleum coke particulate can be produced at the location where the petroleum coke is generated, or the petroleum coke can be processed at another facility. For example, the petroleum coke can be processed into petroleum coke particulate at the facility where the petroleum coke is produced (e.g., at a crude oil refinery), or the petroleum coke can be transported to an offsite processing facility (e.g., proximate a storage facility of live crude oil extraction well) for conversion to the petroleum coke particulate. Transportation of the petroleum coke to an offsite processing facility can provide advantages, such as, but not limited to, allowing for economies of scale in the petroleum coke particulate production process and the ability to buy and sell the petroleum coke and/or petroleum coke particulate on a marketplace.

In step 316, the petroleum coke particulate is transported (e.g., to a processing facility where the petroleum coke particulate is converted into a slurry, as described in connection with step 318). According to one example, the petroleum coke particulate can be transported to a processing facility that is located at, or near, a live well in connection with the extraction of crude oil (e.g., as described in connection with step 320), where it is converted into a petroleum coke slurry. It should be understood that it can be advantageous to transport the petroleum coke as a particulate, before it is converted to a slurry for storage and/or use, where the petroleum coke is being transported by way of truck, rail, or other vessel. For example, the petroleum coke particulate in a slurry may settle and can be difficult to clear from some vessels. Furthermore, petroleum coke particulates can be boxed, bagged, toted, or transported by solid material handling trucks or rail cars, whereas the transportation of petroleum coke slurries by way of trucks or rail cars may require specially configured tanker trucks, tanker railcars, and the like.

In step 318, the slurry is prepared with the petroleum coke particulate. For example, the petroleum coke particulate can be mixed with an amount of water, or other fluid, such that the slurry can flow. The ratio of petroleum coke particulate, water, or other fluid, can be selected such that the viscosity of the slurry is appropriate for a given application, such as, for example, pumping the slurry into a live crude oil extraction well in order to extract crude oil therefrom. According to one example, the slurry could be prepared by mixing the petroleum coke particulate with mud or other compounds, in order to tailor the performance of the slurry for use in connection with one or more steps of the crude oil extraction process.

In step 320, the slurry is injected (e.g., pumped) into the live crude oil extraction well in order to extract crude oil therefrom. The slurry can be prepared and/or formulated to displace, or otherwise extract, crude oil within the well. Additionally, as described above, the petroleum coke slurry can be produced at a processing facility that is located at, or near, the live crude oil extraction well, which provides for streamlined transportation and use of the slurry, as well as providing for integration or combination with other processes at or near the storage facility. For example, step 320 can include pumping the slurry from a slurry production facility/area, e.g., located proximate to the crude oil extraction well, and into the live crude oil extraction well in order to extract crude oil therefrom. After the slurry is injected into the live well and the crude oil is extracted therefrom, the process ends.

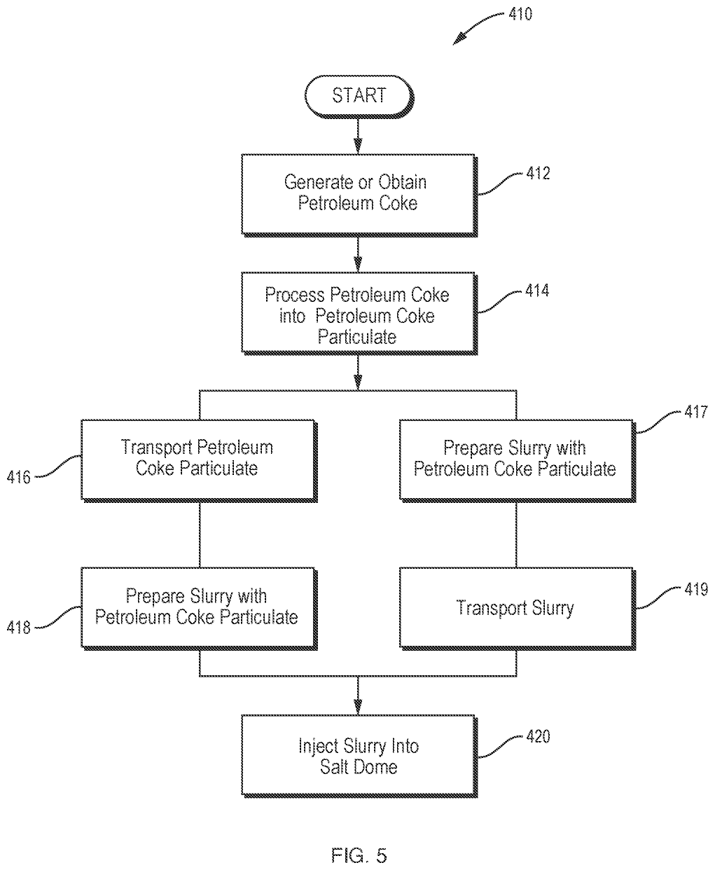

In another aspect, fluidized coke can be transported to a salt dome well and injected into a salt dome well. Salt formations include salt domes, salt swells, salt ridges, salt massifs and bedded salt formations from which domes and ridges can be generated. Salt formations present a sealed system that prevent dispersal of stored material, including fluid and particulate. Referring to FIG. 5, in step 412 petroleum coke is generated or obtained, and in step 414 the petroleum coke is processed into petroleum coke particulate. In step 416, the petroleum coke particulate is transported to a site where, at step 418, a petroleum slurry is prepared from the petroleum coke particulate. Alternatively, at step 417 a slurry can be prepared with the petroleum coke particulate and then, at step 419, the slurry can be transported to a site. The site where the coke is reduced, and also where the slurry is prepared, can be at the coke source, at an intermediate site or at the well site. At step 420 the slurry is injected into the salt dome well. Solid coke could also be transported to the well, fluidized with water at or near the salt dome well site, and injected into the salt dome well. Particles should be smaller than the inside diameter of the pipe delivering the coke to for injection to avoid clogging or plugging of the line. This can be achieved through filtration, use of a sieve, and/or milling or grinding the solid coke either prior to transport or at the site. Large particles can also be used, so the coke need not be significantly altered.

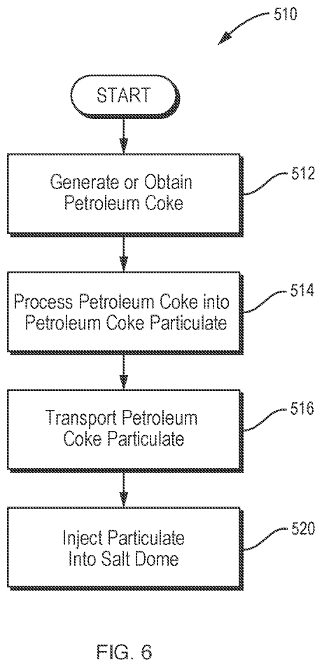

Instead of using water, the petroleum coke could be fluidized using pneumatic transfer using carbon dioxide, methane, natural gas or other gasses to pressurize the coke into the salt dome well. This could be combined with CO2 disposal methods, storage of CH4 and natural gas, etc. Heavier petroleum coke particles settle to the bottom of the formation, consuming capacity over time, but it could be combined with existing injection equipment. An eductor blow through vessel could be used to combine the gas with the solid. Thus, as shown in FIG. 6, dry petroleum coke 512 can be processed 514, transported to location 516 and injected 520 into salt dome 520

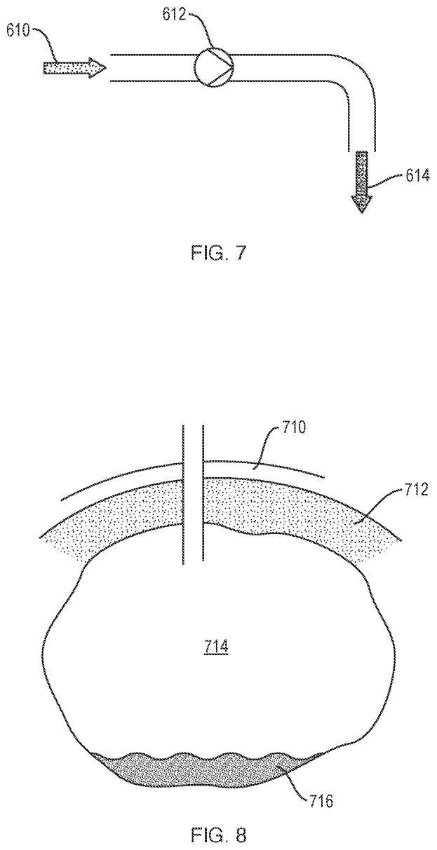

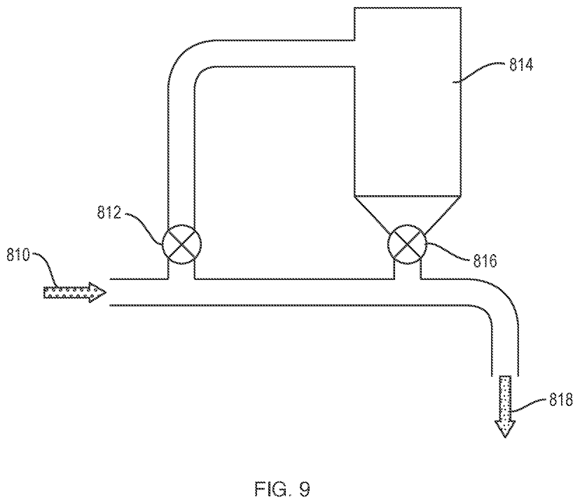

As such, petroleum coke injection into a salt dome well can be done wet, dry via solid transfer, dry via pneumatics or with a hydrocarbon liquid carrier, or any other suitable manner. Referring to FIG. 7, wet injection involves mixing or fluidizing the coke in water and injecting the solid/water mixture 610 into the salt formation 614 via a hydraulic pump 612 (which can be a gear, rotary piston, screw, etc.). Orientation can be horizontal or vertical. The water dissolves the salt and forms a brine (salt water). Salt water is recovered and water is the carrier of the coke. Referring to FIG. 8, salt dome 712 is under cap rock 710. Within the salt dome is gas 714 and sediments 716 of coke which drops out of solution and settles in the formation. Dry solid transfer involves small particle size that might need separation and size reduction so the coke flows like sand or gravel. It is injected into the formation where salt has been removed leaving a void. Referring to FIG. 9, a gravity feed system can be used which could be augmented with periodic gas injection to clear line pluggage and improve distribution. Dry pneumatic transfer includes a carrier gas, such as CO2, natural gas, etc., to transfer the coke to the injection site. The gas is pressurized 810 flows and the coke is metered in, to prevent pluggage, and mixed with the gas. A batch process could be employed where the coke could be gravity fed through a slide or rotary valve 816 from a silo 814 which is raised to gas pressure by gas 810 flowing through valve 812 and into silo 814. Alternatively, a single or multistage piston or press could use pressure from the compressed gas as the driving force. The gas and coke mixture 818 is fed into the salt formation. The pressure could also be generated by mechanical means. These options could be combined with CO2 carbon capture into salt formations, and/or existing gas storage sites such as natural gas, methane, ethane, propane, etc. Hydrocarbon liquid carrier involves mixing coke with hydrocarbon liquids such as crude oil (including Strategic Petroleum Reserve), fuels (diesel, kerosene, gasoline, etc.) or intermediaries (gas oils, naphtha, etc.), and injection into existing (salt already removed) or actively removing formations.

Having thus described the methods of the present disclosure in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A method for petroleum coke carbon capture and sequestration, comprising:
obtaining petroleum coke;
processing the petroleum coke into a petroleum coke particulate;
preparing a slurry including the petroleum coke particulate, the slurry formulated to have a viscosity allowing the slurry to flow;
injecting the slurry into an underground area.

2. The method of claim 1, wherein the step of processing the petroleum coke into a petroleum coke particulate includes processing the petroleum coke with a pneumatic cyclone.

3. The method of claim 1, wherein the step of processing the petroleum coke into a petroleum coke particulate includes processing the petroleum coke through a filtration or sieve device.

4. The method of claim 1, wherein the step of processing the petroleum coke into a petroleum coke particulate includes steam cutting the petroleum coke.

5. The method of claim 1, wherein the step of processing the petroleum coke into a petroleum coke particulate includes grinding the petroleum coke.

6. The method of claim 1, wherein the step of processing the petroleum coke into a petroleum coke particulate includes calcining the petroleum coke to produce calcined coke particulate.

7. The method of claim 1, wherein the underground area is a live crude oil extraction well.

8. The method of claim 7, comprising the step of injecting the slurry into the live crude oil extraction well to displace crude oil therefrom.

9. The method of claim 1, comprising the step of transporting the slurry by way of a pumping system.

10. A method for petroleum coke carbon capture and sequestration, comprising:
obtaining petroleum coke;
processing the petroleum coke into a petroleum coke particulate;
transporting the petroleum coke particulate to a slurry production facility proximate an area of usage;
preparing a slurry including the petroleum coke particulate; and
injecting the slurry into an underground area.

11. The method of claim 10, wherein the step of processing the petroleum coke into a petroleum coke particulate includes processing the petroleum coke with a pneumatic cyclone.

12. The method of claim 10, wherein the step of processing the petroleum coke into a petroleum coke particulate includes processing the petroleum coke through a filtration or sieve device.

13. The method of claim 10, wherein the step of processing the petroleum coke into a petroleum coke particulate includes steam cutting the petroleum coke.

14. The method of claim 10, wherein the step of processing the petroleum coke into a petroleum coke particulate includes grinding the petroleum coke.

15. The method of claim 10, wherein the step of processing the petroleum coke into a petroleum coke particulate includes calcining the petroleum coke to produce calcined coke particulate.

16. The method of claim 10, wherein the underground area is a live crude oil extraction well.

17. The method of claim 16, comprising the step of injecting the slurry into the live crude oil extraction well to displace crude oil therefrom.

18. The method of claim 10, wherein the underground area is an underground storage facility.

19. The method of claim 10, wherein the underground area is a salt formation.

20. A method for petroleum coke carbon capture and sequestration, comprising:
obtaining petroleum coke;
processing the petroleum coke into a petroleum coke particulate;
transporting the petroleum coke particulate to an injection site; and
injecting the coke particulate at the injection site into an underground area.

21. The method of claim 20, wherein the underground area is an underground storage facility.

22. The method of claim 20, wherein the underground area is a salt formation.
